(19) United States
(12) Patent Application Publication
(10) Pub. No.: US 2016/0309532 A1
(43) Pub. Date: Oct. 20, 2016

(54) PRIVATE SOCIAL NETWORKING PLATFORM FOR REAL-TIME CONTENT SHARING

(71) Applicants: Hisense USA Corp., Suwanee, GA (US); Hisense Electric Co., Ltd., Qingdao (CN); Hisense International Co., Ltd., Qingdao (CN)

(72) Inventors: Ke YU, Alpharetta, GA (US); Xiuyuan Shang, Duluth, GA (US)

(73) Assignees: Hisense USA Corp., Suwanee, GA (US); Hisense Electric Co., Ltd., Qingdao (CN); Hisense International Co., Ltd., Qingdao (CN)

(21) Appl. No.: 14/691,106

(22) Filed: Apr. 20, 2015

(51) Int. Cl. H04W 76/02; G06F 3/14; H04W 12/08

(52) U.S. Cl. CPC H04W 76/023; H04W 76/025; H04W 12/08; G06F 3/1454

(57) ABSTRACT

A TV system for real-time sharing content may comprise a TV device and a plurality of mobile terminals. The TV device may establish a wireless connection with each of a plurality of mobile terminals, wherein the plurality of mobile terminals comprises a first mobile terminal as a master mobile terminal to control the device, and a sharing mobile terminal to share a target document stored in the sharing mobile terminal. The TV device may obtain from the sharing mobile terminal an access authorization associated with the target document; and when receiving an instruction from the master mobile terminal to display the target document, display an audio/visual content of the target document on a screen of the TV.

### BACKGROUND

Current Internet technologies make it possible for users to freely communicate through various ways. For example, Internet based social networking platform, such as FACEBOOK™, allows registered users to share video or photos with his/her defined contacts. The shared information, once uploaded, is saved in a remote computer server. The owner of the shared information has no control over the uploaded information. For example, although the owner is able to delete the shared information from his/her personal home page on the social networking platform, the shared information is still stored in the remote computer server. The owner cannot delete the shared information from the remote computer server.

### SUMMARY

Devices and methods in the present disclosure provide a private social networking platform for a group of users to real-time share media content from their mobile terminals. Unlike public social networking platforms, such as FACEBOOK™, where an individual risks losing privacy when he/she shares media content to only a small group of friends, information shared in the platform of the present disclosure is strictly kept among the group of users. The platform is free from losing-privacy issues.

According to an aspect of the present disclosure, a TV device may be configured to establish a wireless connection with each of a plurality of mobile terminals, wherein the plurality of mobile terminals comprises a first mobile terminal as a master mobile terminal to control the device, and a sharing mobile terminal to share a target document stored in the sharing mobile terminal. The TV device may obtain from the sharing mobile terminal an access authorization associated with the target document; and when receiving an instruction from the master mobile terminal to display the target document, display an audio/visual content of the target document on a screen of the TV.

According to another aspect of the present disclosure, a method for sharing information on a TV may comprise: establishing, by a TV device, a wireless connection with each of a plurality of mobile terminals, wherein the plurality of mobile terminals comprises a first mobile terminal as a master mobile terminal to control the device, and a sharing mobile terminal to share a target document stored in the sharing mobile terminal; obtaining, by the TV device, from the sharing mobile terminal an access authorization associated with the target document; and when receiving an instruction from the master mobile terminal to display the target document, displaying, by the TV device, an audio/visual content of the target document on a screen of the TV.

According to yet another aspect of the present disclosure, a mobile terminal may comprise a processor-readable storage medium, comprising a set of instructions for sharing information on a TV; and a processor in communication with the storage medium. When executing the set of instructions the processor may be directed to: establish a wireless connection with a TV; instruct the TV to access a target document stored in a target mobile terminal connected to the TV; and instruct the TV to display an audio/visual content of the target document on a screen of the TV.

### BRIEF DESCRIPTION OF THE DRAWINGS

The above and other features and advantages will become more apparent by describing in detail example embodiments thereof with reference to the attached drawings in which:

FIG. 1 is a schematic diagram illustrating an example embodiment of a TV device;

FIG. 2 is a schematic diagram illustrating an example embodiment of a client device;

FIG. 3 illustrates a social networking platform for real-time content sharing among a few client device;

FIG. 4 is a schematic diagram of a network based social networking platform for real-time content sharing among a few client device;

FIG. 5 illustrates a method for sharing information on a TV device;

FIG. 6 illustrates a method for sharing information on a TV device through a master mobile terminal; and

FIG. 7 illustrates a method for sharing information on a TV device through a servant mobile terminal.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure provides a technology that is able to push (i.e., send) media content from a mobile terminal to a big screen device, such as a TV. The technology not only applies to one-on-one media content pushing scenario, i.e., when only one mobile terminal and one TV (or a TV with a set-top box) are conducting media content transmissions, but also allows multiple mobile users to mutually share their videos or photos simultaneously through a common big screen.

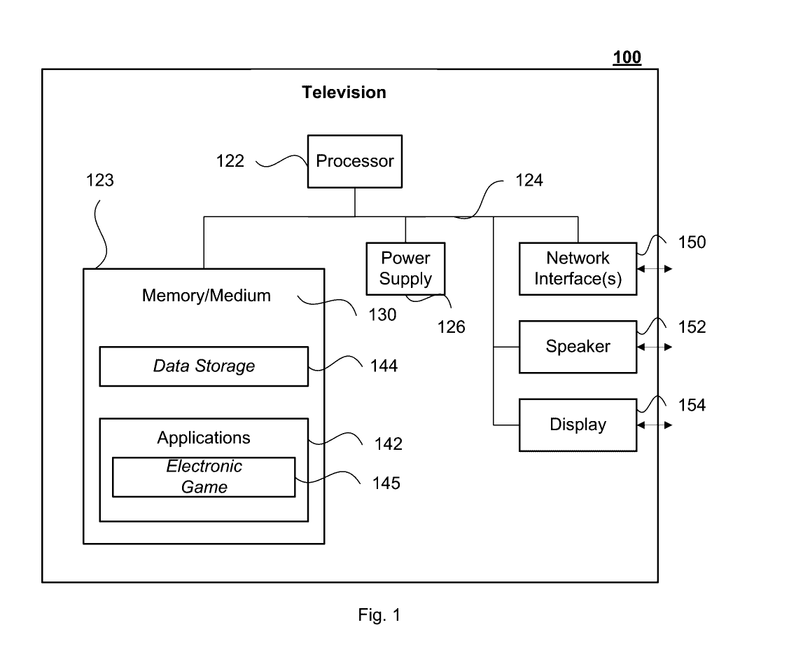

FIG. 1 is a schematic diagram illustrating an example embodiment of a TV device 100 that may be used to implement methods introduced in the present disclosure.

The TV device 100 may be an electronic device, such as a set-top box, configured to connect to a TV to expand functions of the TV. For example, the TV device 100 may include a non-transitory and/or transitory storage medium, such as a memory 130 to store data. The memory 130 may store a variety of possible applications 142, such as a video playing application and/or an electronic game 145. The memory 130 may also be configured to conduct data storage, such as audio-visual data received from the network interface 150. The applications 142 and data 144 may be stored as sets of instructions.

Further, the TV device 100 may include a processor 122 in communication with the processor-readable storage media 130. The processor 122 may execute the sets of instructions and perform the methods and/or operations in example embodiments of the present disclosure. The TV device 100 may also include a power supply 126 for providing electrical power.

The TV device 100 may also be a big screen electronic device, such as a TV, of part of the big screen electronic device designed for playing visual audio media, such as videos, sound tracks, photographs, or other types of multimedia applications and/or documents such as electronic games.

As a TV, the TV device 100 may include a display 154, such as a liquid crystal display (LCD), or a display with a high degree of functionality, such as a touch-sensitive color 2D or 3D display. The display may have a size larger than an ordinary person may feel easy to carry. For example, the display may be bigger than an ordinary computer display. For example, the display may be of a rectangular shape 36 inches between two diagonal corners or bigger. When playing an audio-visual media, the TV device 100 may display visual information on the display 154 and audio information through a speaker 152.

The TV device 100 may include a network interface 150, such as a network card and/or a tuner. The network interface may be a circuit including an antenna and configured to receive signals from and/or send signals to a satellite TV channel and/or a mobile terminal, and/or a TV service server; the network interface may be a circuit including a cable interface and configured to receive cable TV signals and/or send signals to a server connected to the TV cable; and/or the network interface may be a circuit including a network interface and configured to receive signals from and/or send signals to a network, such as Internet.

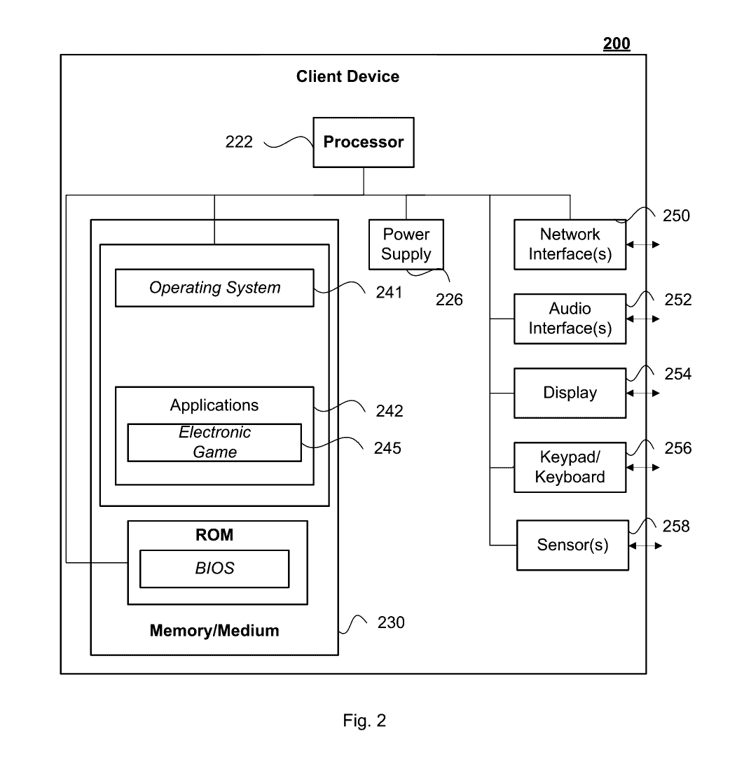

FIG. 2 is a schematic diagram illustrating an example embodiment of a client device, such as a mobile terminal, that may implement and execute methods and software systems in the present disclosure. A client device 200 may be a computing device capable of executing a software system. The client device 200 may, for example, be a device such as a personal desktop computer or a portable device, such as a laptop computer, a tablet computer, a cellular telephone, or a smart phone (i.e., mobile terminal).

The client device 200 may include a keypad/keyboard 256. It may also include a display 254, such as a liquid crystal display (LCD), or a display with a high degree of functionality, such as a touch-sensitive color 2D or 3D display. In contrast, however, as another example, a web-enabled client device 200 may include one or more physical or virtual keyboards, and mass storage medium 230.

The client device 200 may also include or may execute a variety of operating systems 241, including an operating system, such as a mobile operating system, such as iOS™, ANDROID™, or WINDOWS MOBILE™. The client device 200 may include or may execute a variety of possible applications 242, such as an electronic game 245. An application 242 may enable communication with other devices via a network, such as communicating with the TV device 100, a computer or content server via a network.

Further, the client device 200 may include a power supply 226; a wired or wireless network interfaces 250 to communicate an external device, such as an Internet server or a TV; one or more non-transitory processor-readable storage media 230; and one or more processors 222 in communication with the non-transitory processor-readable storage media 230. For example, the non-transitory processor-readable storage media 230 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 230 may store sets of instructions, or units and/or modules that include the sets of instructions, for conducting operations and/or method steps described in the present disclosure. Alternatively, the units and/or modules may be hardware disposed in the client device 200 configured to conduct operations and/or method steps described in the present disclosure. The one or more processors may be configured to execute the sets of instructions and perform the methods and/or operations in example embodiments of the present disclosure.

Merely for illustration, only one processor will be described in an electronic device, such as the TV device and the client device in the disclosure, that execute operations and/or method steps in the following example embodiments. However, it should be note that the electronic device in the present disclosure may also include multiple processors, thus operations and/or method steps that are performed by one processor as described in the present disclosure may also be jointly or separately performed by the multiple processors. For example, if in the present disclosure a processor of an electronic device executes both step A and step B, it should be understood that step A and step B may also be performed by two different processors jointly or separately in the electronic device (e.g., the first processor executes step A and the second processor executes step B, or the first and second processors jointly execute steps A and B).

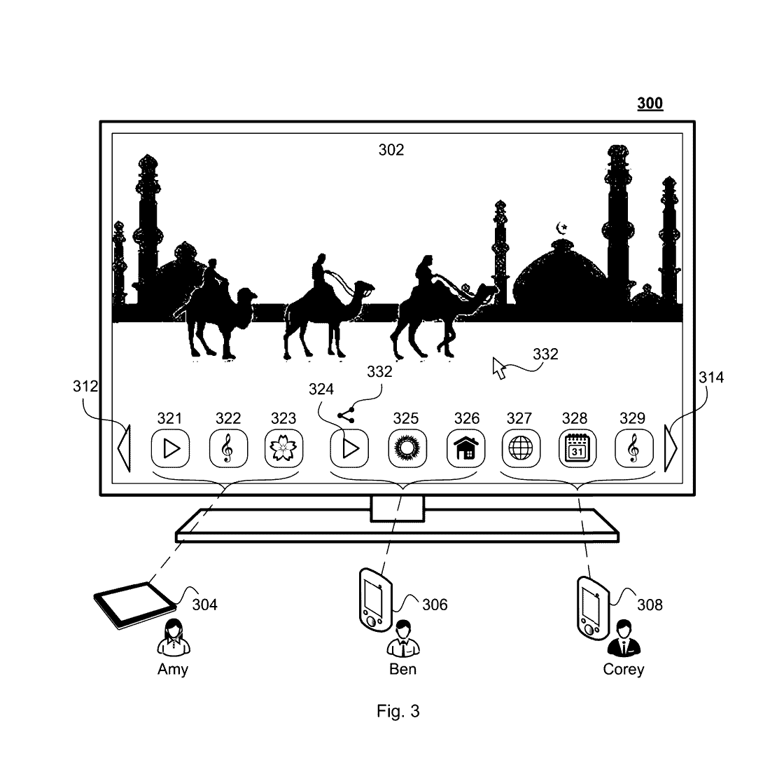

FIG. 3 illustrates a social networking platform 300 for real-time content sharing among a few users. The private social networking platform 300 may include a TV device 302 that provides a private social networking platform for a plurality of client devices 304, 306, 308 to share contents of private documents stored in the plurality of client devices 304, 306, 308. Unlike public social networking platforms, such as FACEBOOK™, where an individual risks losing privacy when he/she shares media content to only a small group of friends, information shared in the platform of the present disclosure is strictly kept among the group of users. The platform is free from losing-privacy issues.

The TV device 302 may be a TV device 100; and the client device 304, 306, 308 may be a client device 200. For illustration purpose, the client devices 304, 306, 308 may be mobile terminals, such as tablets, smart phones etc. The TV device 302 may be a TV. It should be note that the TV device 302 may also be an independent electronic device connected to a TV, as described in FIG. 1.

The TV 302 may include a wireless connection circuit to establish a wireless connection, directly or indirectly, with each of the plurality of mobile terminals 304, 306, 308. For example, the mobile terminals 304, 306, 308 may individually log in the TV 302 to establish the wireless connection via Bluetooth™ connection or via new field communication technology. Alternatively, when the mobile terminal 304, 306, 308 is remote to the TV 302 or when the mobile terminal 304, 306, 308 is connected to WiFi, the TV 302 may connect with the mobile terminal 304, 306, 308 via a wireless router or the WiFi. In FIG. 1, the TV 302 establishes wireless connection with three mobile terminals: the first mobile terminal 304 operated by Amy, the second mobile terminal 306 operated by Ben, and the third mobile terminal 308 operated by Corey. Each of the plurality of mobile terminals 304, 306, 308 may have one or more documents stored therein. For example, the mobile terminal 306 may have a plurality of audio visual documents (e.g., videos, audios, photos etc.) and/or other types of documents saved in a storage medium of the mobile terminal 306.

Once the TV 302 establishes a wireless connection with a mobile terminal 304, 306, 308, the mobile terminal 304, 306, 308 may authorize the TV 302 to access one or more documents (i.e., shared documents) stored in the mobile terminal 304, 306, 308 to share with other users connected to the TV 302. The level of accessibility of the shared document may be defined by the corresponding mobile terminal. Only the authorized document may be accessed by the TV 302. For example, Amy may operate the mobile terminal 304 to give the TV 302 authorization to access a video document 321, an audio document 322, and a photo document 323. The video document 321 may be a single video or may be a folder containing a plurality of videos. Similarly, the audio document 322 may be a single sound track or may be a folder containing a plurality of sound tracks; and the photo document 323 may be a single photo or a folder containing a plurality of photos. Similarly, Ben may operate the mobile terminal 306 to authorize the TV 302 to access documents 324, 325, 326 stored in the mobile terminal 306; and Corey may operate the mobile terminal 308 to authorize the TV 302 to access documents 327, 328, 329. In addition to the video, audio, and photo documents, the mobile terminal 304 may also authorize the TV to access other types of documents that can be displayed on the TV 302. For example, the mobile terminal 306 may authorize the TV 302 to access a POWERPOINT™ file, a WORD™ file, and/or a PDF™ file. The present disclosure does not limit the format of the document that a mobile terminal may authorize the TV to access.

With the authorization from the mobile terminal 304, 306, 308, the TV 302 may obtain the shared documents form the mobile terminals 304, 306, 308. The TV 302 may obtain the entire shared documents from the mobile terminals 304, 306, 308, or only the audio visual portion of the shared documents. When the resolution of the shared document is different than the resolution of the TV 302, the TV 302 may instruct the mobile terminal 304, 306, 308 to modify the shared document to match the resolution of the TV 302. For example, the TV 302 may have a maximum resolution of 1920×1080. When the shared document is an image at a higher resolution, such as 3840×2160, the TV 302 may instruct the corresponding mobile terminal to reduce the resolution of the image to 1920×1080 or a different resolution that is acceptable by the TV 302. Alternatively, the TV 302 may simply download the shared document and make the adjustment by itself.

The TV 302 may obtain all the shared documents with a uniform obtaining strategy. Alternatively, the system may adopt a differential obtaining strategy to obtain different shared documents with different obtaining strategy depending on their characteristics, such as their sizes and/or their privacy levels.

With the uniform obtaining strategy, the TV 302 may directly download the shared documents from the mobile terminals 304, 306, 308 to its memory and display an icon and/or an identification (e.g., name) of the shared documents on the screen of the TV 302. When the TV 302 is instructed to display a shared document, the TV 302 may open the shared document and display the audio/visual content of the shared document on its screen. Alternatively, the TV 302 may first display an identification and/or icon of the shared document, and then download the shared document only when it is instructed to open and display the shared document.

With the differential obtaining strategy, the TV 302 may treat different shared documents differently depending on their sizes. For example, the TV 302 may assign a predetermined size to all shared documents or different predetermined size to different types of shared documents. The TV 302 may directly download a shared document when its size is smaller than the corresponding predetermined size. When a shared document is bigger than its corresponding predetermined size, however, the TV 302 may first display an identification (e.g., name) and/or icon of the shared document, and then download the shared document only when it is instructed to open and display the shared document.

Alternatively, with the differential obtaining strategy, the system may treat different shared documents differently depending on their privacy level. For example, the mobile terminal 304, 306, 308 may assign a privacy level to a shred document. The TV 302 may be allowed to directly access and download a shared document with a first privacy level. When a shared document is assigned to a second privacy level, the TV 302 may first display an identification and/or icon of the shared document, and then download the shared document only when it is instructed to open and display the shared document. When a shared document is assigned to a third privacy level, the mobile terminal 304, 306, 308 may never permit the TV 302 to download the shared document. The TV 302 may display an identification and/or icon of the shared document. When the TV 302 is instructed to display the shared document, it may instruct the corresponding mobile terminal to locally open the shared document and send only the audio/visual content of the opened document to the TV 302 for display. For example, Ben may determine to share contents of a PowerPoint™ file saved in the mobile terminal 306 but may assign the PowerPoint™ file with the third privacy level. Accordingly, the TV 302 may only display the icon and the name (i.e., identification) of the PowerPoint™ file on its screen. When the TV 302 is instructed by the mobile terminal 304 to display the PowerPoint™ file, the TV 302 may instruct the mobile terminal 306 to open the PowerPoint™ file and only send images of the slides in the PowerPoint™ file. Because the metadata of the PowerPoint™ file is never downloaded by the TV 302, the PowerPoint™ file receives the highest privacy protection.

When a mobile terminal 304, 306, 308 logs out of the TV 302, i.e., when the wireless connection between the TV 302 and the mobile terminal 304, 306, 308 is terminated, the TV 302 may erase the shared document corresponding to the mobile terminal 304, 306, 308 from its memory. In an embodiment of the present disclosure, the TV 302 may download a shared document only to its memory. Since the shared document is not stored in a disk (e.g., a hard disk) and/or non-transitory storage medium, the shared document may be un-recoverable once the mobile terminal logs out, thereby the owner (e.g., Amy, Ben, and/or Corey) of the mobile terminal 304, 306, 308 may be able to keep his/her privacy to the largest extent while sharing the shared documents with others.

The TV 302 may identify one of the mobile terminals 304, 306, 308 as a master mobile terminal and identify the rest of the mobile terminals as servant mobile terminals. For example, the TV 302 may assign the mobile terminal 304 as the master mobile terminal and assign the remaining mobile terminals 306, 308 as the servant mobile terminals. The TV 302 may authorize only the master mobile terminal to control the TV 302, and the TV 302 may remain control over the servant mobile terminals. For example, only the master mobile terminal 304 may be able to instruct the TV 302 to open and display a shared document and/or may instruct the TV 302 to terminate or turn off the social networking platform 300. As a result, the master mobile terminal 304 may be able to control the display of any shared documents saved in the servant mobile terminals or the master mobile terminal through its control over the TV 302.

To display a target document from the shared documents, the master mobile terminal 304 may send an instruction to the TV 302 to display and/or browse the target document. For example, the TV 302 may communicate with the master mobile terminal 304 to map the interface shown on the TV screen to the screen of the master mobile terminal 304, so that what Amy sees on the screen of the master mobile terminal 304 is the same as what is shown on the TV screen. Accordingly, Amy may be able to open the target document 321-329 by touch or click it. Alternatively, the TV 304 may display a cursor on its screen. Through a touch screen or a cursor control device on the master mobile terminal 304, Amy may be able to move a cursor 332 on the screen of the TV 302 over target document and click the target document to open it. The target document may be one of the shared documents 321-329, and the mobile terminal 304, 306, 308 that stores the target document may be a sharing mobile terminal.

When receiving the instruction from the master mobile terminal 304 to display the target document, the TV 302 may display the target document on its screen. In the scenario that the TV 302 adopts the uniform document obtaining strategy to all shared document, the TV 302 may directly open the target document when the TV 302 has downloaded the target document to its memory from the corresponding sharing mobile terminal. When the TV 302 only obtains the identification and/or icon of the target document, the TV 302 may download the target document from the corresponding sharing mobile terminal, and then open and display the target document.

In the scenario that the TV 302 adopts the obtaining strategy that differentiates the target document depending on its size and that the target document is larger than the predetermined size, the TV 302 may only have obtained the identification and/or icon of the target document. Thus the TV 302 may first download the target document from the corresponding sharing mobile terminal after receiving the instruction to display the target document, and then open and display the target document.

In the scenario that the TV 302 adopts the obtaining strategy that differentiates the target document depending on its privacy level, if the target document is of the first privacy level, the TV 302 may download the target document to its memory and may directly open and display the target document. If the target document has the second privacy level, the TV 302 may only obtain the identification and/or icon of the target document. Thus the TV 302 may first download the target document from the corresponding mobile terminal after receiving the instruction to display the target document, and then open and display the target document. If the target document has the third privacy level, the TV 302 may instruct the corresponding mobile terminal to locally open the shared document and receive therefrom the audio/visual content of the opened document to display.

Accordingly, the TV 302 may provide a private social networking platform 300 where the mobile terminals 304, 306, and 308 may be able to share one or more shared documents with each other with heightened privacy protection.

The private social networking platform 300 may also allow the mobile terminals to download certain shared documents. In addition to the authorization of access the shared documents, a mobile terminal 304, 306, 308 may also authorize other mobile terminals connected to the TV 302 to download a shared document. To this end, the mobile may assign a downloading authorization to the shared document. The TV 302 may recognize the shared document with the downloading authorization and may identify the shared document with downloading identification 332. For example, in FIG. 3, Ben may authorize Amy and Corey to download the shared document 324. Accordingly, the mobile terminal 306 may assign the downloading authorization to the shared document 324 and the TV 302 may display the downloading identification 332 above the shared document 324, so that Amy and Corey may recognize the shared document 324 easily and may download the shared document 324 if they wish.

To download the shared document, a mobile terminal 304, 306, 308 may send a downloading request to the TV 302. Upon receiving the downloading request, the TV 302 may send the corresponding shared document to the mobile terminal 304, 306, 308. For example, if Amy wishes to download the shared document 324, she may operate the mobile terminal 304 to send a downloading request to the TV 302 in order to receive the shared document 324. When the shared document 324 has been downloaded to the memory of the TV 302, the TV 302 may directly send the shared document 324 to Amy's mobile terminal 304. When the TV 302 has not yet downloaded the shared document 324, the mobile terminal 304 may download the shared document 324 depending on its privacy level. If the shared document 324 is not assigned with a privacy level or is assigned with the first or second privacy level, the TV 302 may download the shared document 324 from the mobile terminal 306 and then send the shared document 324 to the mobile terminal 304; or the TV 302 may send an instruction to the mobile terminal 306 to directly send the shared document 324 to the mobile terminal 304. If, however, the shared document 324 is assigned with the third privacy level, the TV 302 may send an instruction to the mobile terminal 306 to directly send the shared document 324 to the mobile terminal 304. This obtaining strategy may be applied to any shared documents between any two parties of the mobile terminals 304, 306, 308.

The private social networking platform 300 may also allow a member to pass its status as a master mobile terminal to another mobile terminal. The master mobile terminal 304 may first send an instruction to the TV 302 to pass control over the TV 302 to another mobile terminal, e.g., mobile terminal 306. Upon receipt of the instruction, the TV 302 may assign the mobile terminal 304 as a servant mobile terminal to be controlled by the TV 302; and then assign the mobile terminal 304 as a master mobile terminal to control the TV 302. Once the master status is transferred to mobile terminal 306, Ben may be able to control the operation of the TV 302 via the mobile terminal 306 and the mobile terminal 304 may become a servant mobile terminal.

Any servant mobile terminal may log out the private social networking platform 300. For example, when any of the mobile terminals 304, 306, 308 determines to terminate sharing its shared documents, it may log out from the private social networking platform 300, i.e., send a log out notification to the TV 302 and disconnect the wireless connection with the TV 302. Accordingly, the TV 302 may disconnect the wireless connection with the mobile terminal and erase the corresponding shared documents from its memory if they have ever been downloaded.

Only the master mobile terminal may terminate a document sharing event and turn off the private social networking platform. For example, when Amy determines to terminate the document sharing event, she may operate the master mobile terminal 304 to send a termination instruction to the TV 302. Upon receiving the termination instruction, the TV 302 may terminate the wireless connections to all the mobile terminals connect with the TV 302. The TV 302 may then erase all the shared documents from these mobile terminals 304, 306, 308 if they have ever been downloaded.

Because the shared documents are only stored in the memory of the TV 302, the shared documents may ultimately be remove from the TV 302 and may not be recovered. Thereby, the private social networking platform 300 may provide a better privacy for sharing content than public social networking platforms.

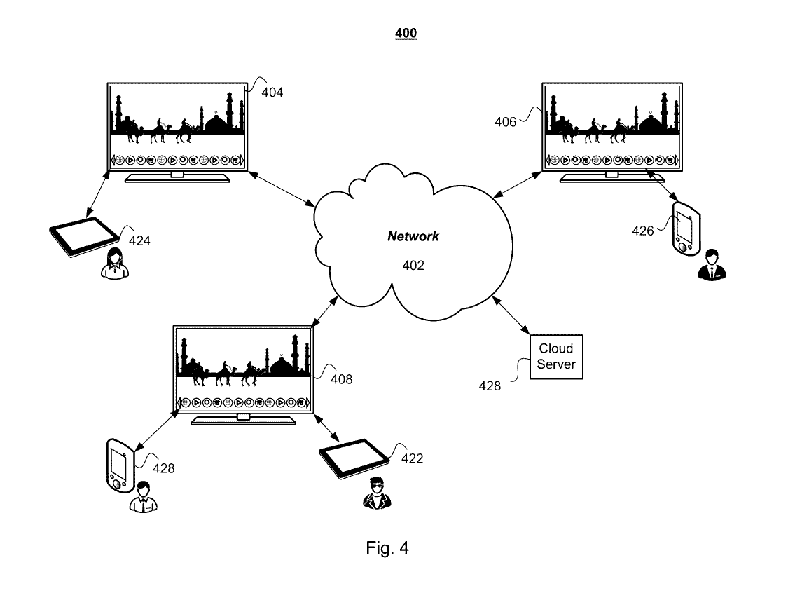

FIG. 4 is a schematic diagram of a network based social networking platform 400 for real-time content sharing among a few users. The system 400 may be an extension of the system 300 from local connection to remote connection. The system 400 may comprise a plurality of TV devices 404, 406, 408. Each of the plurality of TV devices may be of the same structure and function as the TV device 302. The plurality of TV devices 404 may be connected to a cloud server 428 through a network 402.

The network 402 may include a variety of networks, such as Internet, one or more local area networks (LANs) and/or wide area networks (WANs), wire-line type connections, wireless type connections, or any combination thereof. The network 402 may couple devices so that communications may be exchanged, such as between servers and the TV devices 404, 406, 408 or other types of devices, including between wireless devices coupled via a wireless network, for example. A network 402 may also include mass storage, such as network attached storage (NAS), a storage area network (SAN), or other forms of computer or machine readable media, for example.

Each of the plurality of TV devices 404, 406, 408 may connect to one or more client devices, such as one or more of the mobile terminals 422, 424, 426, 428. Any one of the mobile terminals 422, 424, 426, 428 may authorize the corresponding TV device to access and/or download a shared document stored therein in a similar manner set forth in FIG. 3.

Each of the plurality of TV devices 404, 406, 408 may connect to the cloud server 428 via the network 402. The cloud server 428 may coordinates image display among the plurality of TV devices 404, 406, 408, so that the images shown on the plurality of TV devices 404, 406, 408 are synchronized.

One of the TV devices 422, 424, 426, 428 may connect to a master mobile terminal, thereby may serve as a master TV device. The remaining TV devices may connect to one or more servant mobile terminals and thereby may serve as servant TV devices. The master mobile terminal therefore may be able to control the content sharing in the same manner as set forth in FIG. 3. For example, the master mobile terminal may be able to display any shared documents on the master TV device. To this end, the master mobile terminal may instruct, through the master TV device, the TV device local to the shared document to display the shared document in the same manner as set forth in FIG. 3 and share the audio/visual content of the shared document in real-time among all TV devices in the network 402. For example, mobile terminal 424 may be the master mobile terminal. Accordingly, the TV device 404 may be the master TV device in the private social networking platform 400. The master mobile terminal 424 may instruct the master TV 404 to display a target document. The master TV 404 may obtain the target document from directly from the sharing mobile terminal if the sharing mobile terminal is connected to the master TV device 404. If the sharing mobile terminal is connect to a remote TV device, such as TV device 408, the master TV device may direct the TV 408 to download the target document. The master TV device 404 may either direct the TV device 408 to locally open the target document or send the target document to the master TV device 404 for display. The audio/visual content of the opened target document may be shared simultaneously among all participating TV devices 404, 406, 408 via the network 402.

The master mobile terminal may be able to pass its master status to another mobile terminal via the TV devices and the network 402. When the master status is passed to another mobile terminal, the TV device corresponding to the new master mobile terminal may become a new master TV device. For example, the master mobile terminal 424 may instruct the master TV device 404 to pass its master status to servant mobile terminal 426. To this end, the master TV device may assign, via the network 402 and inform all servant TV devices 406, 408, the mobile terminal 426 as the new master terminal device and remove the master status from the mobile terminal 424. After that, the TV device 404 may assign the TV device 406 as the new master TV device and remove the master status from itself. In an example embodiment, the above steps may also be conducted by an independent network server.

When downloading a shared document, the TV device local to the sharing mobile terminal (i.e., the mobile terminal that shares the shared document) may be able to download the shared document and send the shared document to other TV devices via the network 402.

Each TV device may assign a local master mobile terminal among the mobile terminals locally connected to it. So that the local master mobile terminal may control and operate on the corresponding TV device. For example, the servant TV device 408 may assign the servant mobile terminal 422 as a local master TV device to control local operation over the TV device 408. The local master mobile terminal 422 may instruct the TV device 408 to log off the private social networking platform 400.

When a TV device logs off the private social networking platform 400, all the shared documents from the TV devices may be simultaneously removed from memories of all the TV devices in the network. Similarly, when a mobile device logs off the private social networking platform, the shared documents corresponding to the mobile terminal may also be removed from memories of all the TV devices in the network 402.

Termination of the entire private social networking platform 400 may only be conducted by the master mobile device through the master TV device. Once the master mobile device instructed the master TV device to terminate the network connections with other TV devices, all downloaded shared documents may be simultaneously erased from memories of every TV devices in the network 402.

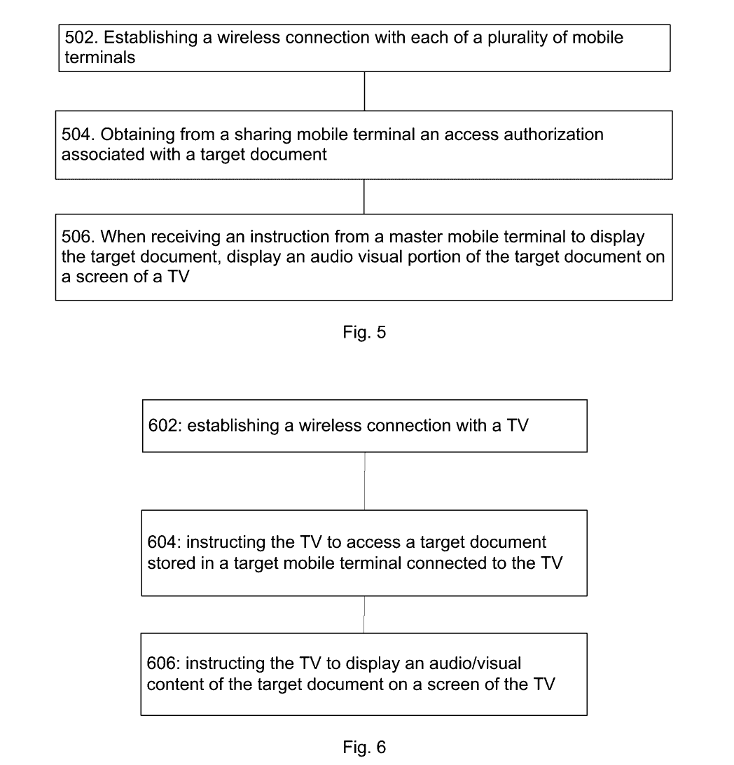

FIG. 5 illustrates a method for sharing information on a TV device according to an example embodiment. The TV device may be the TV device 300 or the network based system 400. The method may be implemented as a set of instruction stored in a storage medium of the TV device and may be executed by a processor of the TV device. The method may comprise:

502: establishing a wireless connection with each of a plurality of mobile terminals, wherein the plurality of mobile terminals comprises a first mobile terminal as a master mobile terminal to control the device, and a sharing mobile terminal to share a target document stored in the sharing mobile terminal.

504: obtaining from the sharing mobile terminal an access authorization associated with the target document.

506: when receiving an instruction from the master mobile terminal to display the target document, display an audio/visual content of the target document on a screen of the TV.

FIG. 6 illustrates a method for sharing information on a TV device through a master mobile terminal, such as a cell phone. The TV device may be the TV device 300 or the network based system 400. The mobile terminal may be the client device 200. The method may be implemented as a set of instruction stored in a storage medium of the mobile terminal and may be executed by a processor of the mobile terminal. The method may comprise:

602: establishing a wireless connection with a TV;

604: instructing the TV to access a target document stored in a target mobile terminal connected to the TV; and

606: instructing the TV to display an audio/visual content of the target document on a screen of the TV.

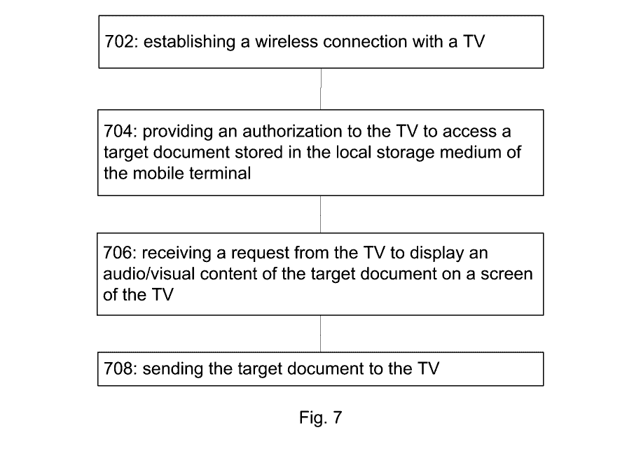

FIG. 7 illustrates a method for sharing information on a TV device through a servant mobile terminal, such as a cell phone. The TV device may be the TV device 300 or the network based system 400. The mobile terminal may be the client device 200. The method may be implemented as a set of instruction stored in a storage medium of the mobile terminal and may be executed by a processor of the mobile terminal. The method may comprise:

702: establishing a wireless connection with a TV;

704: providing an authorization to the TV to access a target document stored in the local storage medium of the mobile terminal;

706: receiving a request from the TV to display an audio/visual content of the target document on a screen of the TV; and

708: sending the target document to the TV.

While example embodiments of the present disclosure relate to systems and methods for real-time content sharing, the systems and methods may also be applied to other Applications. For example, in addition to mobile terminals, the methods and systems may also be applied to non-mobile devices such as a desk top computer, a server of a network, etc. The present disclosure intends to cover the broadest scope of systems and methods for content browsing, generation, and interaction.

Thus, example embodiments illustrated in FIGS. 1-5 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A TV device, comprising:
a processor-readable storage medium, comprising a set of instructions for sharing documents on a TV; and
a processor in communication with the storage medium, wherein when executing the set of instructions the processor is directed to:
establish a wireless connection with each of a plurality of mobile terminals, wherein the plurality of mobile terminals comprises a first mobile terminal that acts as a master mobile terminal to control the device and a sharing mobile terminal containing a target document stored in the sharing mobile terminal;
obtain from the sharing mobile terminal an access authorization associated with the target document; and
after receiving an instruction from the master mobile terminal to display the target document according to the access authorization, display an audio/visual portion of the target document on a screen of the TV.

2. The device of claim 1, wherein the storage medium comprises a transitory storage medium; and
the processor is further directed to:
before receiving the instruction to display the target document access and download the target document only to the transitory storage medium according to the access authorization; and
when receiving an instruction from the master mobile terminal to display the target document, open the target document in the device.

3. The device of claim 2, wherein the processor is further directed to,
when the target document is smaller than a predetermined size, download the target document before receiving the instruction from the master mobile terminal to display the target document; and
when the target document is larger than the predetermined size, download the target document only when receiving the instruction from the master mobile terminal to display the target document.

4. The device of claim 2, wherein the processor is further directed to:
receive a termination instruction from the master mobile terminal;
terminate the wireless connections with the plurality of mobile terminals; and
erase the target document from the transitory storage medium.

5. The device of claim 1, wherein the storage medium comprises a transitory storage medium; and
when receiving an instruction from the master mobile terminal to display the target document, the processor is further directed to:
instruct the sharing mobile terminal to open the target document, and
receive the audio visual portion of the opened target document from the sharing mobile terminal.

6. The device of claim 1, wherein the processor is further directed to:
receive from the sharing mobile terminal a download authorization associated with the target document; and
when receiving a download request from a mobile terminal in the plurality of mobile terminals, send the target document to the mobile terminal.

7. The device of claim 1, wherein when receiving an instruction from the first mobile terminal to pass its master status to another mobile terminal in the plurality of mobile terminals, the processor is further directed to:
assign the first mobile terminal a servant status same as the another mobile terminal; and
assign the another servant mobile terminal as a master mobile terminal to control the device.

8. The device of claim 1, further comprising a wireless communication circuit to establish the wireless connects with the plurality of mobile terminals via a direct wireless connection or a network.

9. The device of claim 1, further comprising the TV.

10. A method for sharing information on a TV, comprising
establishing, by a TV device, a wireless connection with each of a plurality of mobile terminals, wherein the plurality of mobile terminals comprises a first mobile terminal that acts as a master mobile terminal to control the device and a sharing mobile terminal that comprises a target document stored in the sharing mobile terminal, wherein the target document comprises audio/visual content;
obtaining, by the TV device, from the sharing mobile terminal an access authorization associated with the target document; and
after receiving an instruction from the master mobile terminal to display the target document, displaying, by the TV device, the audio/visual content of the target document on a screen of the TV according to the access authorization.

11. The method of claim 10, wherein the TV device comprises a transitory storage medium; and
the method further comprising:
before receiving the instruction to display the target document, accessing and downloading, by the TV device, the target document only to the transitory storage medium according to the access authorization; and
when receiving an instruction from the master mobile terminal to display the target document, opening, by the TV device, the target document in the device.

12. The method of claim 11, further comprising:
when the target document is smaller than a predetermined size, downloading, by the TV device, the target document before receiving the instruction from the master mobile terminal to display the target document; and
when the target document is larger than the predetermined size, downloading, by the TV device, the target document only when receiving the instruction from the master mobile terminal to display the target document.

13. The method of claim 11, further comprising:
receiving, by the TV device, a termination instruction from the master mobile terminal;
terminating, by the TV device, the wireless connections with the plurality of mobile terminals; and
erasing, by the TV device, the target document from the transitory storage medium.

14. The method of claim 10, wherein the TV device comprises a transitory storage medium; and
the method further comprises, when the TV device receives an instruction from the master mobile terminal to display the target document:
instructing, by the TV device, the sharing mobile terminal to open the target document, and
receiving, by the TV device, the audio/visual content of the opened target document from the sharing mobile terminal.

15. The method of claim 10, further comprising:
receiving, by the TV device, from the sharing mobile terminal a download authorization associated with the target document; and
when receiving a download request from a mobile terminal in the plurality of mobile terminals, sending, by the TV device, the target document to the mobile terminal.

16. The method of claim 10, further comprising, when receiving an instruction from the first mobile terminal to pass its master status to another mobile terminal in the plurality of mobile terminals:
assigning, by the TV device, the first mobile terminal a servant status same as the another mobile terminal; and
assigning, by the TV device, the another servant mobile terminal as a master mobile terminal to control the device.

17. The method of claim 10, wherein each the wireless connections with the plurality of mobile terminals is established via direct wireless connection or a network connection.

18. The method of claim 10, wherein the TV device comprises the TV.

19. A mobile terminal, comprising:
a processor-readable storage medium, comprising a set of instructions for sharing information on a TV; and
a processor in communication with the storage medium, wherein when executing the set of instructions the processor is directed to:
establish a wireless connection with a TV;
instruct the TV to access a target document stored in a target mobile terminal connected to the TV; and
instruct the TV to display an audio/visual content of the target document on a screen of the TV.

20. The mobile terminal of claim 19, wherein the processor is further direct to:
authorize the TV to access a shared document stored in the mobile terminal; and
when receiving an instruction to display the shared document from the TV, open the shared document and send an audio/visual content of the shared document to the TV.
